(19) United States
(12) Patent Application Publication
(10) Pub. No.: US 2021/0063561 A1
(43) Pub. Date: Mar. 4, 2021

(54) RADAR DEVICE AND SIGNAL PROCESSOR

(71) Applicant: Mitsubishi Electric Corporation, Tokyo (JP)

(72) Inventors: Tetsutaro YAMADA, Tokyo (JP); Tomoyuki KOYANAGI, Tokyo (JP); Toshihiko ARIOKA, Tokyo (JP); Hiroaki ISHIKAWA, Tokyo (JP); Hiroshi KAMEDA, Tokyo (JP)

(73) Assignee: Mitsubishi Electric Corporation, Tokyo (JP)

(21) Appl. No.: 17/096,521

(22) Filed: Nov. 12, 2020

Related U.S. Application Data
(63) Continuation of application No. PCT/JP2018/022080, filed on Jun. 8, 2018.

(51) Int. Cl. G01S 13/58; G01S 13/95; H04W 4/90; G01S 13/88

(52) U.S. Cl. CPC G01S 13/589; G01S 13/582; G01S 13/886; H04W 4/90; G01S 13/951

(57) ABSTRACT

A radar device includes processing circuitry to select multiple combinations of one or more cells consecutively arranged, out of multiple cells included in an observation region, assume that an object of observation is present in each of the selected cell combinations, and set up each of objects of observation as a target candidate, and calculate the flow rate of a cell in which each target candidate is present, by using the flow velocity of the cell in which the target candidate is present, out of the calculated flow velocities and determine whether each target candidate has a possibility of being an object of observation on the basis of the flow rate are disposed, and specify a target candidate which has been determined continuously with respect to time to have a possibility of being an object of observation, and recognize the specified target candidate as an object of observation.

### CROSS REFERENCE TO RELATED APPLICATION

This application is a Continuation of PCT International Application No. PCT/JP2018/022080, filed on Jun. 8, 2018, which is hereby expressly incorporated by reference into the present application.

### TECHNICAL FIELD

The present disclosure relates to a radar device and a signal processor that recognize, as an object of observation, a target candidate which has been determined continuously with respect to time to have a possibility of being an object of observation.

### BACKGROUND ART

As devices that detect the occurrence of a tsunami, radar devices that measure the flow velocity of a sea surface by radar and detect the occurrence of a tsunami from the flow velocity of the sea surface are known.

However, the flow velocity of a sea surface measured by a radar device includes either an observation error caused by the influence of thermal noises in a radar receiving unit or an observation error caused by the influence of flow velocity changes by the wind.

Thus, even though the radar device performs a process of detecting a tsunami on the basis of the flow velocity of the sea surface, there are cases in which the erroneous or unsuccessful detection of a tsunami occurs.

The following Patent Literature 1 discloses a radar device that smooths the flow velocity of a sea surface corresponding to a cell included in a detection area where there is a possibility that a tsunami occurs and estimates that the smoothed flow velocity is the flow velocity of the sea surface in the detection area, as a measure for reducing the erroneous detection of a tsunami or the unsuccessful detection of a tsunami.

### CITATION LIST

### Patent Literature

Patent Literature 1: WO 2018/037533

### SUMMARY OF INVENTION

### Technical Problem

In the radar device disclosed in Patent Literature 1, observation errors included in the flow velocity of the sea surface are reduced.

However, the radar device disclosed in Patent Literature 1 doesn't detect the occurrence of a tsunami in consideration of the time continuity of a tsunami, but detects the occurrence of a tsunami only from the flow velocity at one sampling time.

Thus, a problem with the radar device disclosed in Patent Literature 1 is that there are cases in which even when the flow velocity temporarily increases for some reason, the radar device erroneously recognizes the occurrence of a tsunami.

The present disclosure is made in order to solve the above-mentioned problem, and it is therefore an object of the present disclosure to provide a radar device and a signal processor capable of preventing the erroneous detection of an object of observation.

### Solution to Problem

A radar device according to the present disclosure includes: processing circuitry to: radiate an electromagnetic wave toward an observation region and receiving the electromagnetic wave returning from the observation region; calculate each of flow velocities of multiple cells included in the observation region from the received electromagnetic wave; select multiple combinations of one or more cells consecutively arranged, out of the multiple cells included in the observation region, assume that an object of observation is present in each of the selected cell combinations, and set up each of objects of observation as a target candidate; calculate a flow rate of a cell in which each target candidate is present, by using the flow velocity of the cell in which the target candidate is present, out of the calculated flow velocities, and determine whether each target candidate has a possibility of being an object of observation, on a basis of the flow rate; and specify a target candidate which has been determined continuously with respect to time to have a possibility of being an object of observation, out of target candidates each of which is determined to have a possibility of being an object of observation, and recognize the specified target candidate as an object of observation, wherein the processing circuitry predicts a combination of cells in each of which there is a possibility that a target candidate which is determined to have a possibility of being an object of observation is present at a next sampling time, and, when a target candidate which is determined to have a possibility of being an object of observation is present in the predicted cell combination at the next sampling time, the processing circuitry recognizes that the target candidate is an object of observation, and wherein the processing circuitry predicts, as a combination of cells in each of which there is a possibility of being present at the next sampling time, a combination of cells each being present, at a current sampling time, in a traveling direction of a target candidate which is determined to have a possibility of being an object of observation.

### Advantageous Effects of Invention

According to the present disclosure, the radar device is constructed in such a way that the radar device includes the candidate setting unit for selecting multiple combinations of one or more cells consecutively arranged, out of the multiple cells included in the observation region, and for assuming that an object of observation is present in each of the selected cell combinations, to set up each of objects of observation as a target candidate, and the temporary determining unit for calculating the flow rate of a cell in which each target candidate is present, by using the flow velocity of the cell in which the target candidate is present, out of the flow velocities calculated by the flow velocity calculating unit, and for determining whether each target candidate has a possibility of being an object of observation, on the basis of the flow rate are disposed, and the target recognizing unit specifies a target candidate which has been determined continuously with respect to time to have a possibility of being an object of observation, out of the target candidates each of which is determined to have a possibility of being an object of observation by the temporary determining unit, and recognizes the specified target candidate as an object of observation. Therefore, the radar device according to the present disclosure can prevent the erroneous detection of an object of observation.

### BRIEF DESCRIPTION OF DRAWINGS

FIG. 1 is a block diagram showing a radar device according to Embodiment 1;

FIG. 2 is a hardware block diagram showing the hardware of a signal processor 5;

FIG. 3 is a hardware block diagram of a computer in the case in which the signal processor 5 is implemented by software, firmware, or the like;

FIG. 4 is a flowchart showing a processing procedure in the case in which the signal processor 5 is implemented by software, firmware, or the like;

FIG. 5 is an explanatory drawing showing the sea surface of an observation region to which an electromagnetic wave is radiated from an antenna 3;

FIG. 6 is an explanatory drawing showing an example of a setup of target candidates i which is performed by a candidate setting unit 10;

FIG. 7 is an explanatory drawing showing an example of the setup of target candidates i which is performed by the candidate setting unit 10;

FIG. 8 is an explanatory drawing showing an example of a setup of a gate which is performed by a target tracking unit 17;

FIG. 9A is an explanatory drawing showing an example in which the distance between target candidates i and i+1 is long, and FIG. 9B is an explanatory drawing showing an example in which the distance between target candidates i and i+1 is short;

FIG. 10A is an explanatory drawing showing an example in which the difference α in inclination between target candidates i and i+1 is large, and FIG. 10B is an explanatory drawing showing an example in which the difference α in inclination between target candidates i and i+1 is small;

FIG. 11A is an explanatory drawing showing an example in which the difference ΔLen between the length Lenₜ of a target candidate i at a sampling time t and the length Lenₜ₊₁ of the target candidate i at a sampling time t+1 is small, and FIG. 11B is an explanatory drawing showing an example in which the difference ΔLen between the length Lenₜ of a target candidate i at a sampling time t and the length Lenₜ₊₁ of the target candidate i at a sampling time t+1 is large; and

FIG. 12A is an explanatory drawing showing an example in which the difference Δβ between the inclination βₜ of a target candidate i at a sampling time t and the inclination βₜ₊₁ of the target candidate i at a sampling time t+1 is small, and FIG. 12B is an explanatory drawing showing an example in which the difference Δβ between the inclination βₜ of a target candidate i at a sampling time t and the inclination βₜ₊₁ of the target candidate i at a sampling time t+1 is large.

### DESCRIPTION OF EMBODIMENTS

In order to explain the present disclosure in greater detail, embodiments of the present disclosure will be described with reference to the accompanying drawings.

### Embodiment 1

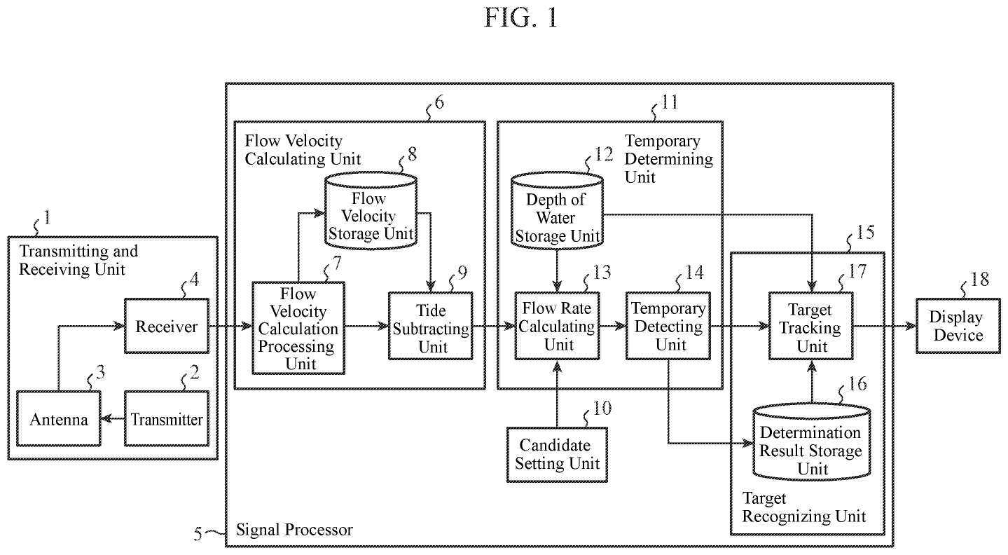

FIG. 1 is a block diagram showing a radar device according to Embodiment 1.

In Embodiment 1, a radar device in which an object of observation is a tsunami will be explained.

However, this is only an example, and, for example, the radar device can be one in which an object of observation is a wind or a cloud.

In FIG. 1, a transmitting and receiving unit 1 includes a transmitter 2, an antenna 3, and a receiver 4.

The transmitting and receiving unit 1 radiates an electromagnetic wave toward the sea surface of an observation region and, after that, receives the electromagnetic wave returning from the observation region.

The transmitter 2 radiates an electromagnetic wave toward the sea surface of the observation region from the antenna 3.

The antenna 3 radiates the electromagnetic wave toward the sea surface of the observation regions and, after that, receives, as a reflected wave, the electromagnetic wave reflected on the sea surface and returned.

The receiver 4 performs signal processing on a received signal of the reflected wave received by the antenna 3. The signal processing on the received signal includes a process of amplifying the received signal and a process of converting the frequency of the received signal.

The receiver 4 converts the received signal after the signal processing from an analog signal into a digital signal, and outputs the digital signal to a signal processor 5.

The signal processor 5 includes a flow velocity calculating unit 6, a candidate setting unit 10, a temporary determining unit 11, and a target recognizing unit 15.

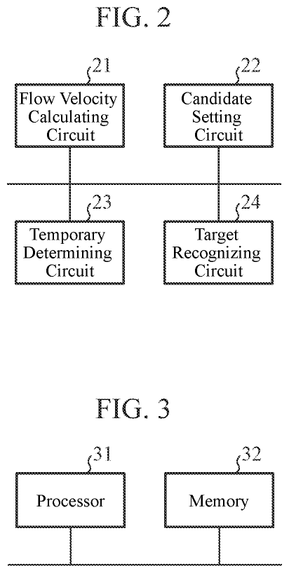

FIG. 2 is a hardware block diagram showing the hardware of the signal processor 5.

The flow velocity calculating unit 6 includes a flow velocity calculation processing unit 7, a flow velocity storage unit 8, and a tide subtracting unit 9, and is implemented by, for example, a flow velocity calculating circuit 21 shown in FIG. 2.

The flow velocity calculating unit 6 calculates a flow velocity v_{d,n,t} at a sampling time t in each of multiple cells included in the sea surface of the observation region from the digital signal outputted from the receiver 4.

The multiple cells included in the sea surface are small regions into which the sea surface of the observation region is divided with respect to both a range direction and an azimuth direction, and each cell is denoted by C_{d,n} hereafter.

d is a variable showing the range direction of each cell C_{d,n}, where d=1, 2, . . . , or D.

n is a variable showing the azimuth direction of each cell C_{d,n}, where n=1, 2, . . . , or N.

The flow velocity calculation processing unit 7 calculates the flow velocity v_{d,n,t} at the sampling time t in each cell C_{d,n} included in the sea surface of the observation region from the digital signal outputted from the receiver 4.

The flow velocity calculation processing unit 7 outputs the flow velocity v_{d,n,t} at the sampling time t in each cell C_{d,n} to each of the following units: the flow velocity storage unit 8 and the tide subtracting unit 9.

The flow velocity storage unit 8 is a storage medium for storing the flow velocity v_{d,n,t} at the sampling time t outputted from the flow velocity calculation processing unit 7.

The tide subtracting unit 9 estimates a tide component tide_{d,n} which is a long period component of the flow velocity of each cell C_{d,n} from the flow velocities at past sampling times which are stored by the flow velocity storage unit 8.

The tide subtracting unit 9 subtracts the tide component tide_{d,n} from the flow velocity v_{d,n,t} at the sampling time t in each cell C_{d,n}, and outputs the flow velocity v′_{d,n,t} after the subtraction of the tide component to the temporary determining unit 11.

The candidate setting unit 10 is implemented by, for example, a candidate setting circuit 22 shown in FIG. 2.

The candidate setting unit 10 selects multiple combinations each containing one or more cells consecutively arranged, out of the multiple cells included in the observation region.

The candidate setting unit 10 assumes that a wave front of a tsunami which is an object of observation is present in each of the selected cell combinations, and sets up each object of observation as a target candidate i. i is a variable for identifying each target candidate.

Hereafter, each of one or more cells in each of which a target candidate i is present is expressed by Cⱼ, and the flow velocity of each cell Cⱼ is expressed by vⱼ.

The temporary determining unit 11 includes a depth of water storage unit 12, a flow rate calculating unit 13, and a temporary detecting unit 14, and is implemented by, for example, a temporary determining circuit 23 shown in FIG. 2.

By using the flow velocity vⱼ, after the tide component subtraction, of each cell Cⱼ in which a target candidate i is present, out of the flow velocities v′_{d,n,t} after the tide component subtraction which are outputted from the tide subtracting unit 9, the temporary determining unit 11 calculates the flow rate Fᵢ of each cell Cⱼ in which the target candidate i is present. It is assumed that the flow rate of each cell Cⱼ in which the target candidate i is present has the same value Fᵢ.

The temporary determining unit 11 determines whether the target candidate i has a possibility of being an object of observation on the basis of the flow rate Fᵢ of each cell Cⱼ in which the target candidate i is present.

The depth of water storage unit 12 is a storage medium for storing the depth of water h_{d,n} of each cell C_{d,n} as the depth of water of the one of the multiple cells included in the observation region.

The flow rate calculating unit 13 acquires the depth of water hⱼ of each cell Cⱼ in which the target candidate i is present, out of the depths of water of the multiple cells stored in the depth of water storage unit 12.

The flow rate calculating unit 13 calculates the flow rate Fᵢ of each cell Cⱼ in which the target candidate i is present by using the flow velocity vⱼ of the cell Cⱼ, the depth of water hⱼ of the cell Cⱼ, and an angle θⱼ which the normal vector of the target candidate i forms with the velocity vector of the flow velocity vⱼ of the cell Cⱼ, and a standard deviation σⱼ of the flow rate of the cell Cⱼ.

The flow rate calculating unit 13 outputs the flow rate Fᵢ of each cell Cⱼ in which the target candidate i is present to the temporary detecting unit 14.

The temporary detecting unit 14 calculates a score Lᵢ by using the flow rate Fᵢ outputted from the flow rate calculating unit 13, and a standard deviation σ_{Fi} of a flow rate distribution of each cell Cⱼ in which the target candidate i is present when the target candidate i is not an object of observation.

The temporary detecting unit 14 compares the score Lᵢ and a threshold Th, and, when the score Lᵢ is greater than the threshold Th, determines that the target candidate i has a possibility of being an object of observation.

When the score Lᵢ is equal to or less than the threshold Th, the temporary detecting unit 14 determines that the target candidate i doesn't have a possibility of being an object of observation.

The temporary detecting unit 14 outputs a determination result showing whether the target candidate i has a possibility of being an object of observation to the target recognizing unit 15.

The target recognizing unit 15 includes a determination result storage unit 16 and a target tracking unit 17, and is implemented by, for example, a target recognizing circuit 24 shown in FIG. 2.

The target recognizing unit 15 specifies a target candidate which has been determined continuously with respect to time to have a possibility of being an object of observation, out of the target candidates i each of which is determined to have a possibility of being an object of observation by the temporary determining unit 11, and recognizes the specified target candidate as an object of observation.

The determination result storage unit 16 is a storage medium for storing the determination result outputted from the temporary detecting unit 14.

When the determination result outputted from the temporary detecting unit 14 shows that the target candidate i has a possibility of being an object of observation, the target tracking unit 17 predicts a combination of cells in each of which there is a possibility that the target candidate i is present at the next sampling time t+1. For example, the target tracking unit 17 predicts a combination of cells being present in the traveling direction of the target candidate i, as the combination of cells in each of which there is a possibility that the target candidate is present at the next sampling time t+1.

At the next sampling time t+1, when the determination result outputted from the temporary detecting unit 14 shows that the target candidate i has a possibility of being an object of observation, the target tracking unit 17 recognizes the target candidate i as an object of observation.

A display device 18 is implemented by a graphics processing unit (GPU), and a liquid crystal display or the like.

The display device 18 displays the target candidate i which is recognized by the target tracking unit 17 as a wave front of a tsunami which is an object of observation, and so on.

In FIG. 1, it is assumed that each of the following units: the flow velocity calculating unit 6, the candidate setting unit 10, the temporary determining unit 11, and the target recognizing unit 15 which are the components of the signal processor 5 is implemented by hardware for exclusive use as shown in FIG. 2. More specifically, it is assumed that the signal processor 5 is implemented by the flow velocity calculating circuit 21, the candidate setting circuit 22, the temporary determining circuit 23, and the target recognizing circuit 24.

Here, each of the following units: the flow velocity calculating circuit 21, the candidate setting circuit 22, the temporary determining circuit 23, and the target recognizing circuit 24 is, for example, a single circuit, a composite circuit, a programmable processor, a parallel programmable processor, an application specific integrated circuit (ASIC), a field-programmable gate array (FPGA), or a combination of these circuits.

The components of the signal processor 5 are not limited to ones each implemented by hardware for exclusive use, and the signal processor 5 may be implemented by software, firmware, or a combination of software and firmware.

The software or the firmware is stored as a program in a memory of a computer. The computer refers to hardware that executes a program, and is, for example, a central processing unit (CPU), a central processing device, a processing device, an arithmetic device, a microprocessor, a microcomputer, a processor, or a digital signal processor (DSP).

FIG. 3 is a hardware block diagram of the computer in the case in which the signal processor 5 is implemented by software, firmware, or the like.

In the case in which the signal processor 5 is implemented by software, firmware, or the like, a program for causing the computer to perform processing procedures of the flow velocity calculating unit 6, the candidate setting unit 10, the temporary determining unit 11, and the target recognizing unit 15 is stored in a memory 32. A processor 31 of the computer executes the program stored in the memory 32.

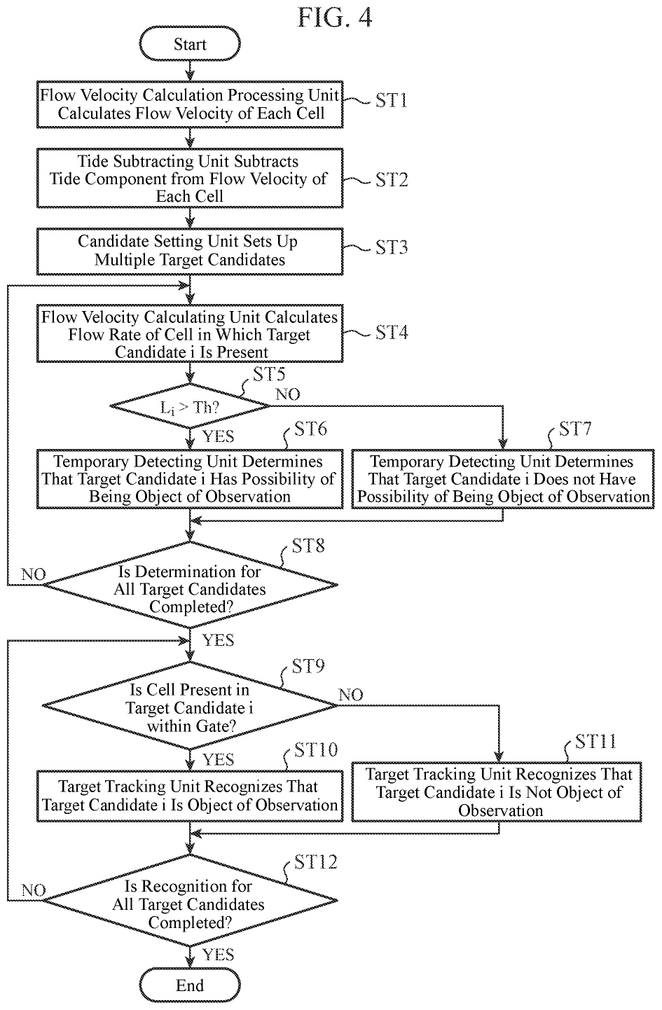

FIG. 4 is a flowchart showing a processing procedure in the case in which the signal processor 5 is implemented by software, firmware, or the like.

Further, although the example in which each of the components of the signal processor 5 is implemented by hardware for exclusive use is shown in FIG. 2, and the example in which the signal processor 5 is implemented with software, firmware, or the like is shown in FIG. 3, some components in the signal processor 5 may be implemented by hardware for exclusive use and the remaining components may be implemented by software, firmware, or the like.

Next, the operation of the radar device shown in FIG. 1 will be explained.

First, the transmitter 2 radiates an electromagnetic wave toward the sea surface of the observation region from the antenna 3.

Although it doesn't matter the type of the electromagnetic wave radiated from the antenna 3, an electromagnetic wave having a frequency of approximately 3 to 30 MHz in a short wave band, an electromagnetic wave having a frequency of approximately 30 to 300 MHz in an ultrashort wave band, or the like is radiated from the antenna 3.

When the transmitter 2 radiates an electromagnetic wave in a short wave band or an ultrashort wave band toward the sea surface of the observation region from the antenna 3 installed, for example, on land, a reflected wave of the electromagnetic wave returns to the antenna 3, the reflected wave being reflected on an ocean surface wave propagating in the same direction as the electromagnetic wave.

The reflected wave of the electromagnetic wave reflected on an ocean surface wave is a signal having large electric power, the signal having a wavelength which is one-half the wavelength of the electromagnetic wave radiated from the antenna 3.

The reason why the electric power of the reflected wave of the electromagnetic wave reflected on an ocean surface wave is large is that the phase of the electromagnetic wave reflected on a certain ocean surface wave matches the phase of the electromagnetic wave reflected on another ocean surface wave adjacent to the ocean surface wave due to resonant Bragg scattering.

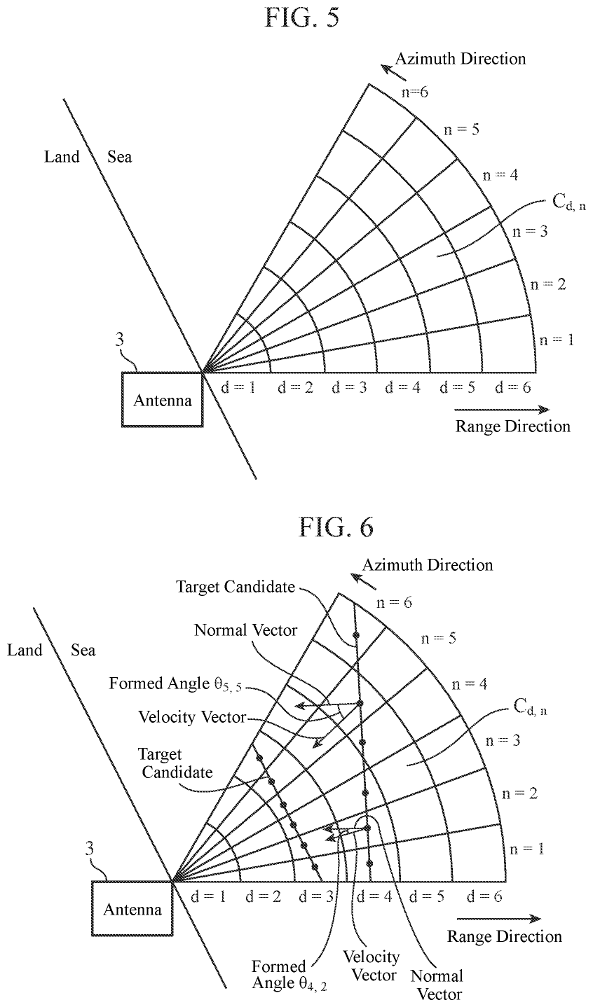

FIG. 5 is an explanatory drawing showing the sea surface of the observation region toward which an electromagnetic wave is radiated from the antenna 3.

The sea surface of the observation region is divided in a range direction and in an azimuth direction, and the sea surface of the observation region shown in FIG. 5 is divided into 6×6 cells C_{d,n} as an example.

The antenna 3 radiates an electromagnetic wave toward the sea surface of the observation region and, after that, receives, as a reflected wave, the electromagnetic wave reflected on the sea surface and returned.

The receiver 4 performs signal processing on a received signal of the reflected wave received by the antenna 3.

The receiver 4 converts the received signal after the signal processing from an analog signal into a digital signal, and outputs the digital signal to the signal processor 5.

When receiving the digital signal from the receiver 4, the flow velocity calculation processing unit 7 calculates the flow velocity v_{d,n,t} at the sampling time t in each cell C_{d,n} from the digital signal (step ST1 of FIG. 4).

More specifically, the flow velocity calculation processing unit 7 calculates the flow velocity v_{d,n,t} at the sampling time t in each cell C_{d,n} by performing a Fourier transform in the azimuth direction on the digital signal and then performing a Fourier transform in the range direction on the Fourier transform result in the azimuth direction.

The flow velocity calculation processing unit 7 outputs the flow velocity v_{d,n,t} at the sampling time t in each cell C_{d,n} to each of the following units: the flow velocity storage unit 8 and the tide subtracting unit 9.

The tide subtracting unit 9 acquires the flow velocities at past sampling times in each cell C_{d,n}, the flow velocities being stored in the flow velocity storage unit 8.

The tide subtracting unit 9 estimates a tide component tide_{d,n} which is a long period component of the flow velocity of each cell C_{d,n} by using the flow velocities at past sampling times, as shown in the following equation (1).

$${tide}_{d , n} = \frac{1}{M} {\sum }_{k = L - M - L}^{L - 1 - L} {v}_{d , n , k} \qquad ( 1 )$$

In the equation (1), M denotes the number of flow velocities at past sampling times, and L denotes a margin for causing the flow velocity v_{d,n,t} at the sampling time t that there is a possibility that a tsunami has occurred not to be included in the equation (1).

Here, the tide subtracting unit 9 estimates the tide component tide_{d,n} by using the equation (1). However, this is only an example, and the tide subtracting unit 9 may estimate the tide component tide_{d,n} by using a Kalman filter.

The tide subtracting unit 9 subtracts the tide component tide_{d,n} from the flow velocity v_{d,n,t} at the sampling time t in each cell C_{d,n}, as shown in the following equation (2), and outputs the flow velocity v′_{d,n,t} after the subtraction of the tide component to the temporary determining unit 11 (step ST2 of FIG. 4).

v′_{d,n,t}=v_{d,n,t}−tide_{d,n} (2)

The candidate setting unit 10 selects multiple combinations each containing one or more cells consecutively arranged, out of the multiple cells included in the observation region.

The candidate setting unit 10 assumes that a wave front of a tsunami which is an object of observation is present in each of the selected cell combinations, and sets up each object of observation as a target candidate i (step ST3 of FIG. 4).

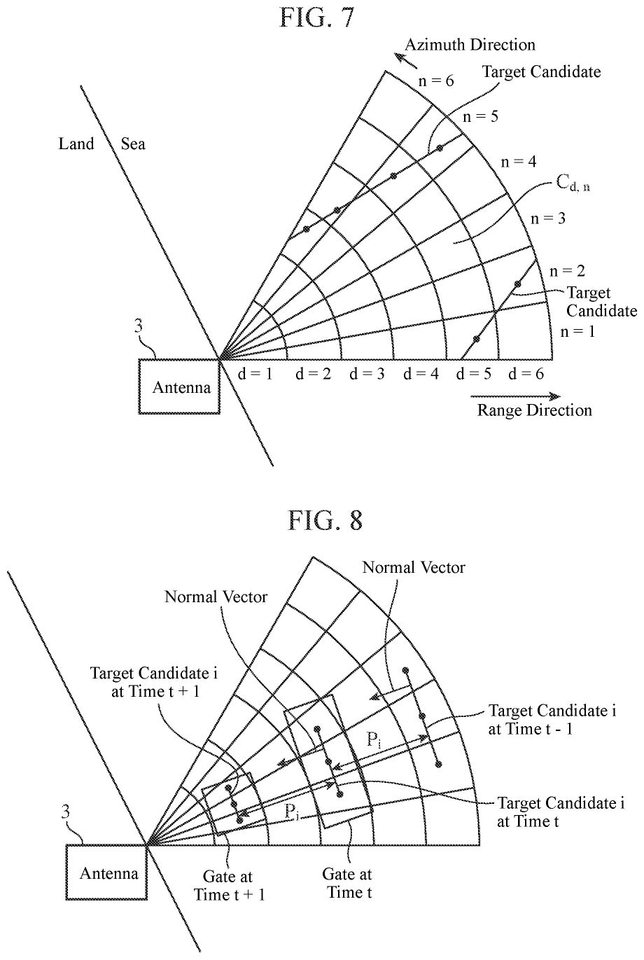

FIGS. 6 and 7 are explanatory drawings showing examples of a setup of a target candidate i which is performed by the candidate setting unit 10.

In FIGS. 6 and 7, ⋅ shows a cell in which a target candidate i is present.

In FIG. 6, the candidate setting unit 10 selects multiple combinations starting from each of the cells C_{1,1} to C_{6,1} of n=1 in the azimuth direction and ending at each of the cells C_{1,6} to C_{6,6} of n=6 in the azimuth direction.

In FIG. 6, 36 (=6×6) combinations are selected because d=1, 2, . . . , or 6. Note that, (D×D) combinations are selected in the case of d=1, 2, . . . , or D.

In FIG. 6, for the sake of avoiding the complexity of the drawing, only some combinations out of the 36 combinations are illustrated.

In FIG. 6, a combination of the cells C_{4,1}, C_{4,2}, C_{4,3}, C_{5,4}, C_{5,5}, and C_{6,6} and a combination of the cells C_{3,1}, C_{3,2}, C_{3,3}, C_{3,4}, C_{3,5}, and C_{3,6} are illustrated.

In the combination of the cells C_{4,1}, C_{4,2}, C_{4,3}, C_{5,4}, C_{5,5}, and C_{6,6}, the cell C_{4,4}, instead of the cell C_{5,4}, may be included. However, because the alignment of the cells in the case of including the cell C_{5,4} becomes more linear than that in the case of including the cell C_{4,4}, the cell C_{5,4} is included in the combination in FIG. 6.

In FIG. 6, the candidate setting unit 10 selects multiple combinations starting from each of the cells C_{1,1} to C_{6,1} of n=1 in the azimuth direction and ending at each of the cells C_{1,6} to C_{6,6} of n=6 in the azimuth direction.

However, this is only an example, and the candidate setting unit 10 may select multiple combinations starting from each of the cells C_{1,1} to C_{6,1} of n=1 in the azimuth direction and ending at each of the cells of n=5, 4, or 3 in the azimuth direction.

Instead, the candidate setting unit 10 may select multiple combinations starting from each of the cells of n=2, 3, or 4 in the azimuth direction and ending at each of the cells C_{1,6} to C_{6,6} of n=6 in the azimuth direction.

Instead, the candidate setting unit 10 may select multiple combinations starting from each of the cells of n=2 or 3 in the azimuth direction and ending at each of the cells of n=5 or 4 in the azimuth direction.

In FIG. 7, multiple combinations starting from each of the cells C_{6,1} to C_{6,6} of d=6 in the range direction which are the cells at the furthest distance from the antenna 3 and ending at each of the cells C_{1,1} to C_{6,1} of n=1 in the azimuth direction are selected. As an alternative, multiple combinations starting from each of the cells C_{6,1} to C_{6,6} of d=6 in the range direction and ending at each of the cells C_{1,6} to C_{6,6} of n=6 in the azimuth direction are selected. In FIG. 7, 72 (=(6+6)×6) combinations are selected because d=1, 2, . . . , or 6 and n=1, 2, . . . , or 6. Note that, (D+D)×N combinations are selected in the case of d=1, 2, . . . , or D and n=1, 2, . . . , or N.

In FIG. 7, for the sake of avoiding the complexity of the drawing, only some combinations out of the 72 combinations are illustrated.

More specifically, a combination of the cells C_{6,2} and C_{5,1} and a combination of the cells C_{6,5}, C_{5,5}, C_{4,6}, and C_{3,6} are illustrated.

Here, FIGS. 6 and 7 are illustrated as examples of setting up a target candidate i. However, any combination may be selected as long as the combination contains one or more cells consecutively arranged, and the setup is not limited to the setup examples shown in FIGS. 6 and 7.

When receiving the flow velocities after the tide component subtraction from the tide subtracting unit 9, the flow rate calculating unit 13 acquires the flow velocity vⱼ after the tide component subtraction of each cell Cⱼ in which the target candidate i set up by the candidate setting unit 10 is present, out of the flow velocities v′_{d,n,t} after the tide component subtraction.

Here, each cell in which the target candidate i is present, out of the multiple cells included in the observation region, is expressed by Cⱼ. When the combination of cells in each of which the target candidate i is present is, for example, the combination of the four cells C_{6,5}, C_{5,5}, C_{4,6}, and C_{3,6}, as shown in FIG. 7, C₁=C_{6,5}, C₂=C_{5,5}, C₃=C_{4,6}, and C₄=C_{3,6} are satisfied.

The flow rate calculating unit 13 acquires the depth of water hⱼ of each cell Cⱼ in which the target candidate i is present, out of the depths of water of the multiple cells stored in the depth of water storage unit 12.

The flow rate calculating unit 13 calculates the flow rate Fᵢ of each cell C by using the flow velocity vⱼ of the cell Cⱼ, the depth of water hⱼ of the cell Cⱼ, and the angle θⱼ which the normal vector of the target candidate i forms with the velocity vector of the flow velocity vⱼ of the cell Cⱼ, and the standard deviation σⱼ of the flow rate of the cell Cⱼ (step ST4 of FIG. 4), as shown in the following equation (3).

$$\begin{matrix}{F}_{i} = \frac{1}{{G}_{i}} {\sum }_{j ∈ {E}_{i}} \frac{cos {θ}_{j} {v}_{j}}{{σ}_{j}^{2} {h}_{j}} & ( 3 ) \\ {G}_{i} = {\sum }_{j ∈ {E}_{i}} \frac{{cos}^{2} {θ}_{j} {v}_{j}}{{σ}_{j}^{2} {h}_{j}} & ( 4 )\end{matrix}$$

In the equations (3) and (4), Eᵢ denotes the set of the cells Cⱼ in each of which the target candidate i is present.

In FIG. 6, as the formed angle θⱼ in each cell Cⱼ in which the target candidate i is present, the angle θ_{5,5} which the normal vector forms with the velocity vector of the flow velocity of the cell C_{5,5}, and the angle θ_{4,2} which the normal vector forms with the velocity vector of the flow velocity of the cell C_{4,2} are illustrated.

Because cos θ_{5,5}<cos θ_{4,2}, the flow velocity of the cell C_{4,2} has a larger weight than the flow velocity of the cell C_{5,5} in the calculation of the flow rate Fᵢ of each cell Cⱼ.

When the target candidate i is a wave front of a tsunami, the traveling direction of the target candidate i has a high possibility of being the direction of the normal vector of the target candidate i, and thus the accuracy of calculation of the flow rate Fᵢ of each cell Cⱼ is improved through the assignment of the weight as mentioned above to the flow velocity of the cell C_{4,2}.

The flow rate calculating unit 13 outputs the flow rate Fᵢ of each cell Cⱼ in which the target candidate i is present to the temporary detecting unit 14.

When receiving the flow rate Fᵢ of each cell Cⱼ in which the target candidate i is present from the flow rate calculating unit 13, the temporary detecting unit 14 calculates the score Lᵢ by using the flow rate Fᵢ and the standard deviation σ_{Fi}, as shown in the following equation (5). The standard deviation σ_{Fi} is standard deviation of the flow rate distribution of the one or more cells Cⱼ in each of which the target candidate i is present, and the standard deviation is calculated when no tsunami occurs.

$${L}_{i} = \frac{{F}_{i}}{{σ}_{Fi}} \qquad ( 5 )$$

The temporary detecting unit 14 compares the score Lᵢ and the threshold Th (step ST5 of FIG. 4). The threshold Th may be stored in an internal memory of the temporary detecting unit 14, or may be provided from the outside.

When the score Lᵢ is greater than the threshold Th (Yes in step ST5 of FIG. 4), the temporary detecting unit 14 determines that the target candidate i has a possibility of being an object of observation (step ST6 of FIG. 4).

When the score Lᵢ is equal to or less than the threshold Th (No in step ST5 of FIG. 4), the temporary detecting unit 14 determines that the target candidate i doesn't have a possibility of being an object of observation (step ST7 of FIG. 4).

The temporary detecting unit 14 stores a determination result showing whether the target candidate i has a possibility of being an object of observation in the determination result storage unit 16. Further, the temporary detecting unit 14 outputs the determination result to the target tracking unit 17.

The temporary detecting unit 14 determines, as to all the target candidates set up by the candidate setting unit 10, whether or not the determination of whether there is a possibility that each target candidate is an object of observation is completed (step ST8 of FIG. 4).

When there remains a target candidate for which the determination has not been completed (No in step ST8 of FIG. 4), the temporary detecting unit 14 instructs the flow rate calculating unit 13 to calculate the flow rate for the target candidate for which the determination has not been completed, in order to repeat the processes of steps ST4 to ST7.

When the determination for all the target candidates has been completed (Yes in step ST8 of FIG. 4), the temporary detecting unit 14 instructs the target tracking unit 17 to start the process.

When receiving the instruction to start the process from the temporary detecting unit 14, the target tracking unit 17 starts the following process.

When the determination result outputted from the temporary detecting unit 14 shows that the target candidate i has a possibility of being an object of observation, the target tracking unit 17 performs the process of predicting a combination of cells in each of which there is a possibility that the target candidate i is present at the next sampling time t+1.

More specifically, the target tracking unit 17 assumes that the traveling direction of the target candidate i is the direction of the normal vector of the target candidate i, and predicts, as the combination of cells in each of which there is a possibility that the target candidate i is present at the next sampling time t+1, a combination of cells being present in the direction of the normal vector.

Concretely, the target tracking unit 17 predicts a combination of cells in each of which there is a possibility that the target candidate i is present at the next sampling time t+1 in the following way.

The target tracking unit 17 calculates the distance Pᵢ which the target candidate i at the sampling time t will travel until the next sampling time t+1, as shown in the following equation (6).

$$\begin{matrix}{P}_{i} = {e}_{i} \times T & ( 6 ) \\ {e}_{i} = \sqrt{g \times {h}_{ave}} & ( 7 ) \\ {h}_{ave} = \frac{1}{{E}_{i}} {\sum }_{i ∈ {E}_{i}} {h}_{j} & ( 8 )\end{matrix}$$

In the equations (6) to (8), T denotes the sampling time interval, and g denotes the acceleration of gravity.

The target tracking unit 17 specifies a combination of cells in each of which the distance from the target candidate i at the sampling time t is Pᵢ, out of the combinations of cells being present in the direction of the normal vector of the target candidate i.

The target tracking unit 17 sets up a cell group including the specified combination of cells as a gate.

FIG. 8 is an explanatory drawing showing an example of a setup of a gate which is performed by the target tracking unit 17.

In FIG. 8, the target tracking unit 17 sets up a gate at the sampling time t when the sampling time is t−1, and sets up a gate at the sampling time t+1 when the sampling time is t.

In FIG. 8, the size of the gate is substantially the same as that of the specified combination of cells. However, this is only an example, and the size of the gate should be just greater than that of the specified combination of cells.

Here, the target tracking unit 17 predicts a combination of cells in each of which there is a possibility that the target candidate i is present at the next sampling time t+1 on the basis of the direction of the normal vector of the target candidate i and the distance Pᵢ.

However, this is only an example, and the target tracking unit 17 may predict a combination of cells in each of which there is a possibility that the target candidate i is present at the next sampling time t+1 by performing a process of tracking the target candidate i on the basis of a past position and the speed of the target candidate i.

As a method of the tracking process, a method of using a Kalman filter, multiple hypothesis tracking (MHT), or the like is known.

The target tracking unit 17 determines whether the determination result of the temporary detecting unit 14 at the sampling time t+1 shows that the target candidate i has a possibility of being an object of observation, and each cell Cⱼ in which the target candidate i is present is within the gate at the sampling time t+1 (step ST9 of FIG. 4).

When the determination result of the temporary detecting unit 14 shows that there is a possibility of being an object of observation and each cell C is within the gate (Yes in step ST9 of FIG. 4), the target tracking unit 17 recognizes that the target candidate i is an object of observation (step ST10 of FIG. 4).

When each cell Cⱼ is not within the gate even though the determination result of the temporary detecting unit 14 shows that there is a possibility of being an object of observation (No in step ST9 of FIG. 4), the target tracking unit 17 recognizes that the target candidate i is not an object of observation (step ST11 of FIG. 4).

When the determination result of the temporary detecting unit 14 shows that there is no possibility of being an object of observation, the target tracking unit 17 recognizes that the target candidate i is not an object of observation.

Here, when it has been determined continuously twice that the target candidate i has a possibility of being an object of observation, the target tracking unit 17 recognizes that the target candidate i is an object of observation.

However, this is only an example, and, in the case in which, for example, N times is set as the prescribed number of times for the determination of whether there is a possibility of being an object of observation, the target tracking unit 17 recognizes that the target candidate i is an object of observation when it has been determined continuously N times that there is a possibility of being an object of observation.

For example, in the case of N=3, when the following conditions (1) to (3) are satisfied, the target tracking unit 17 recognizes that the target candidate i is an object of observation.

### Condition (1)

The determination result of the temporary detecting unit 14 at the sampling time t−1 shows that the target candidate i has a possibility of being an object of observation.

### Condition (2)

The determination result of the temporary detecting unit 14 at the sampling time t shows that the target candidate i has a possibility of being an object of observation, and each cell Cⱼ in which the target candidate i is present is within the gate at the sampling time t.

### Condition (3)

The determination result of the temporary detecting unit 14 at the sampling time t+1 shows that the target candidate i has a possibility of being an object of observation, and each cell Cⱼ in which the target candidate i is present is within the gate at the sampling time t+1.

The target tracking unit 17 determines, as to each of all the target candidates i which are determined to have a possibility of being an object of observation by the temporary detecting unit 14, whether or not the determination of whether the target candidate is an object of observation is completed (step ST12 of FIG. 4).

When there remains a target candidate for which the determination has not been completed (No in step ST12 of FIG. 4), the target tracking unit 17 repeatedly performs the processes of steps ST9 to ST11.

When the determination for all the target candidates is completed (Yes in step ST12 of FIG. 4), the target tracking unit 17 instructs the display device 18 to start the display process.

When receiving the instruction to start the display process from the target tracking unit 17, the display device 18 displays the target candidate i which is recognized to be an object of observation by the target tracking unit 17, and so on.

In above-mentioned Embodiment 1, the radar device is constructed in such a way that the radar device includes the candidate setting unit 10 for selecting multiple combinations of one or more cells consecutively arranged, out of the multiple cells included in the observation region, and for assuming that an object of observation is present in each of the selected cell combinations, to set up each of objects of observation as a target candidate, and the temporary determining unit 11 for calculating the flow rate of a cell in which each target candidate is present, by using the flow velocity of the cell in which the target candidate is present, out of the flow velocities calculated by the flow velocity calculating unit 6, and for determining whether each target candidate has a possibility of being an object of observation on the basis of the flow rate are disposed, and the target recognizing unit 15 specifies a target candidate which has been determined continuously with respect to time to have a possibility of being an object of observation, out of the target candidates each of which is determined to have a possibility of being an object of observation by the temporary determining unit 11, and recognizes the specified target candidate as an object of observation. Therefore, the radar device of Embodiment 1 can prevent the erroneous detection of an object of observation.

In the radar device shown in FIG. 1, when the score Lᵢ is greater than the threshold Th, the temporary detecting unit 14 determines that the target candidate i has a possibility of being an object of observation. Therefore, when the score Lᵢ is greater than the threshold Th, two or more target candidates are determined to have a possibility of being an object of observation by the temporary detecting unit 14.

When determining that two or more target candidates have a possibility of being an object of observation, the temporary detecting unit 14 determines the two or more target candidates as different target candidates when the distance or distances between the two or more target candidates are equal to or greater than a threshold Lₜₕ.

When the distance or distances between the two or more target candidates are less than the threshold Lₜₕ, the temporary detecting unit 14 determines the two or more target candidates as one identical target candidate. As the threshold Lₜₕ, a value which is one-half of the distance between wave fronts of an assumed tsunami, or the like is set up. The threshold Lₜₕ may be stored in an internal memory of the temporary detecting unit 14, or may be provided from the outside.

Concretely, it is as follows.

Hereafter, for the sake of simplicity, it is assumed that as the two or more target candidates having a possibility of being object of observation, two target candidates (a target candidate i and a target candidate i+1) are detected by the temporary detecting unit 14.

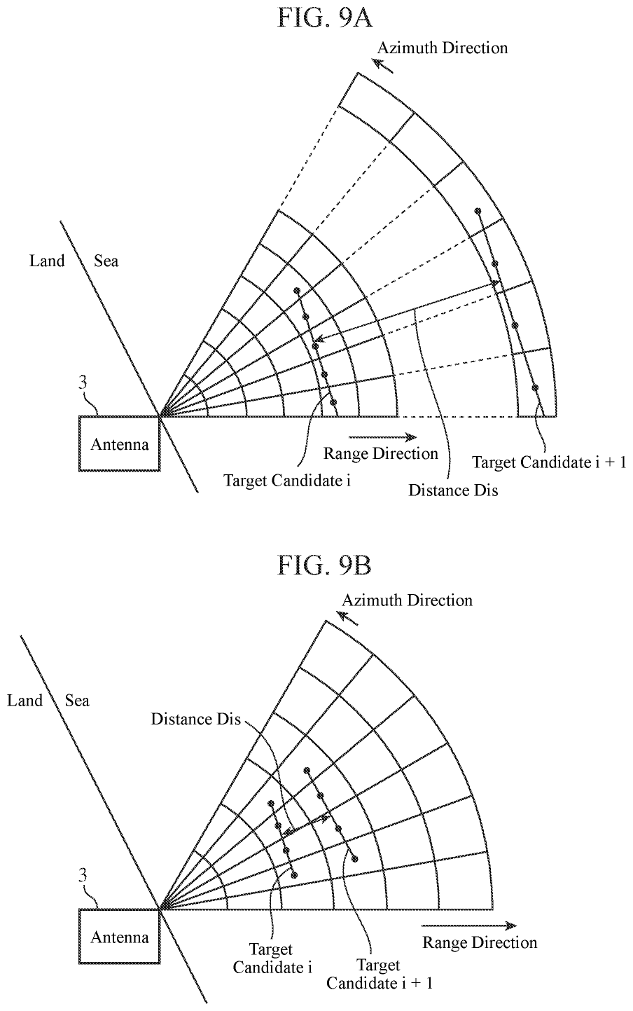

FIG. 9 is an explanatory drawing showing an example in which the two target candidates (the target candidates i and i+1) are detected by the temporary detecting unit 14. FIG. 9A shows an example in which the distance between the target candidates i and i+1 is long, and FIG. 9B shows an example in which the distance between the target candidates i and i+1 is short.

It is assumed that the distance Dis between the target candidates i and i+1 is equal to or greater than the threshold Lₜₕ in FIG. 9A, and the distance Dis between the target candidates i and i+1 is less than the threshold Lₜₕ in FIG. 9B.

The temporary detecting unit 14 calculates the distance Dis between the target candidates i and i+1.

More specifically, the temporary detecting unit 14 calculates the centroid position of the target candidate i and the centroid position of the target candidate i+1, and calculates the distance between the two centroid positions as the distance Dis between the target candidates i and i+1.

Next, the temporary detecting unit 14 compares the distance Dis and the threshold Lₜₕ.

When the distance Dis is equal to or greater than the threshold Lₜₕ, as shown in FIG. 9A, because there is a high possibility that the target candidates i and i+1 are different wave fronts of a tsunami, the temporary detecting unit 14 determines the target candidates i and i+1 as different target candidates.

When the distance Dis is less than the threshold Lₜₕ, as shown in FIG. 9B, because there is a high possibility that the target candidates i and i+1 are an identical wave front of a tsunami or results of erroneous detection, the temporary detecting unit 14 determines the target candidates i and i+1 as one identical target candidate.

In the case of determining the target candidates i and i+1 as one identical target candidate, the temporary detecting unit 14 may discard either the target candidate i or the target candidate i+1, or may perform averaging of the positions of the cells Cⱼ in which the two target candidates is present, or the like.

By determining the two target candidates as one identical target candidate, while the processing load of the target recognizing unit 15 can be reduced, the erroneous detection of a tsunami can be prevented.

Here, the temporary detecting unit 14 determines whether or not to regard the two or more target candidates as different target candidates on the basis of the distance or distances Dis between the two or more target candidates.

However, this is only an example, and the temporary detecting unit 14 may determine whether or not to regard the two or more target candidates as different target candidates on the basis of, for example, the difference or differences a in inclination between the two or more target candidates.

Concretely, it is as follows.

Hereafter, for the sake of simplicity, it is assumed that as the two or more target candidates having a possibility of being an object of observation, two target candidates (a target candidate i and a target candidate i+1) are detected by the temporary detecting unit 14.

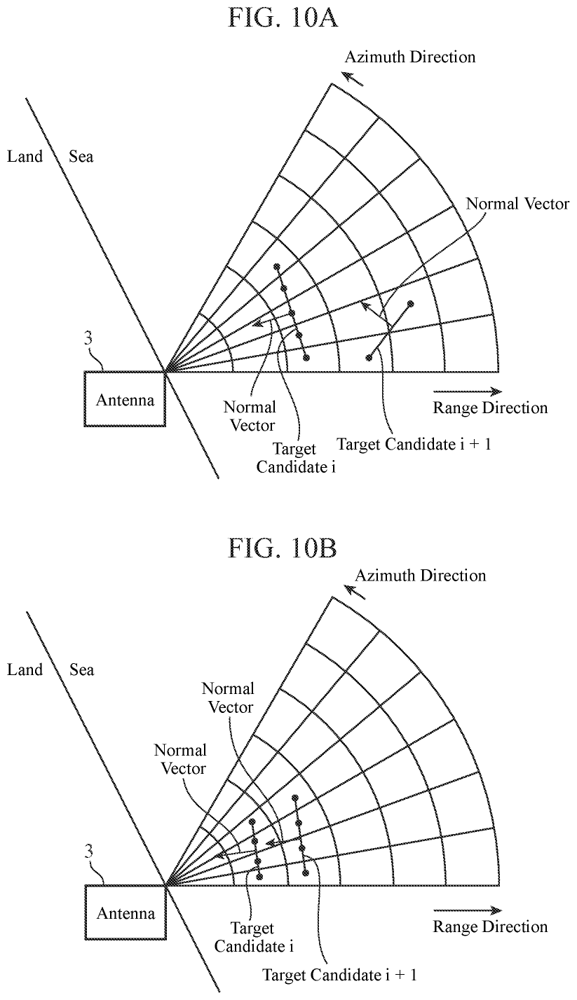

FIG. 10 is an explanatory drawing showing an example in which the two target candidates (the target candidates i and i+1) are detected by the temporary detecting unit 14.

FIG. 10A shows an example in which the difference α in inclination between the target candidates i and i+1 is large, and FIG. 10B shows an example in which the difference a in inclination between the target candidates i and i+1 is small.

It is assumed that the difference α in inclination between the target candidates i and i+1 is equal to or greater than a threshold αₜₕ in FIG. 10A, and the difference α in inclination between the target candidates i and i+1 is less than the threshold αₜₕ in FIG. 10B.

The temporary detecting unit 14 calculates the difference α in inclination between the target candidates i and i+1.

More specifically, the temporary detecting unit 14 calculates, as the inclination difference α, the difference between the direction of the normal vector of the target candidate i and the direction of the normal vector of the target candidate i+1.

The temporary detecting unit 14 compares the inclination difference a and the threshold αₜₕ. As the threshold αₜₕ, a value which is one-half of the difference in inclination between wave fronts of an assumed tsunami, or the like is set up. The threshold αₜₕ may be stored in an internal memory of the temporary detecting unit 14, or may be provided from the outside.

When the inclination difference α is equal to or greater than the threshold αₜₕ, as shown in FIG. 10A, because there is a high possibility that the target candidates i and i+1 are different wave fronts of a tsunami, the temporary detecting unit 14 determines the target candidates i and i+1 as different target candidates.

When the inclination difference α is less than the threshold αₜₕ, as shown in FIG. 10B, because there is a high possibility that the target candidates i and i+1 are an identical wave front of a tsunami or results of erroneous detection, the temporary detecting unit 14 determines the target candidates i and i+1 as one identical target candidate.

### Embodiment 2

In the radar device of Embodiment 1, the target recognizing unit 15 specifies a target candidate which has been determined continuously with respect to time to have a possibility of being an object of observation, out of the target candidates each of which is determined to have a possibility of being an object of observation by the temporary determining unit 11, and recognizes the specified target candidate as an object of observation.

In Embodiment 2, a radar device that includes a condition about the length of target candidates as a condition for recognizing, as an object of observation, a target candidate which is determined to have a possibility of being an object of observation by a temporary determining unit 11 will be explained.

The configuration of the radar device of Embodiment 2 is shown in FIG. 1, like that of the radar device of Embodiment 1.

First, a target tracking unit 17 performs the same determination as that of Embodiment 1.

More specifically, the target tracking unit 17 determines whether a determination result of a temporary detecting unit 14 at a sampling time t+1 shows that a target candidate i has a possibility of being an object of observation, and each cell Cⱼ in which the target candidate i is present is within a gate at the sampling time t+1.

Next, when the determination result of the temporary detecting unit 14 shows that there is a possibility of being an object of observation, and each cell Cⱼ is within the gate, the target tracking unit 17 determines whether the target candidate i satisfies the condition about the length.

The condition about the length is that the difference ΔLen between the length Lenₜ of the target candidate i at the current sampling time t and the length Lenₜ₊₁ of the target candidate i at the next sampling time t+1 is equal to or less than a threshold Lenₜₕ.

The length Lenₜ of the target candidate i is the length of the target candidate i which is determined at the sampling time t to have a possibility of being an object of observation.

The length Lenₜ₊₁ of the target candidate i is the length of the target candidate i which is determined at the sampling time t+1 to have a possibility of being an object of observation.

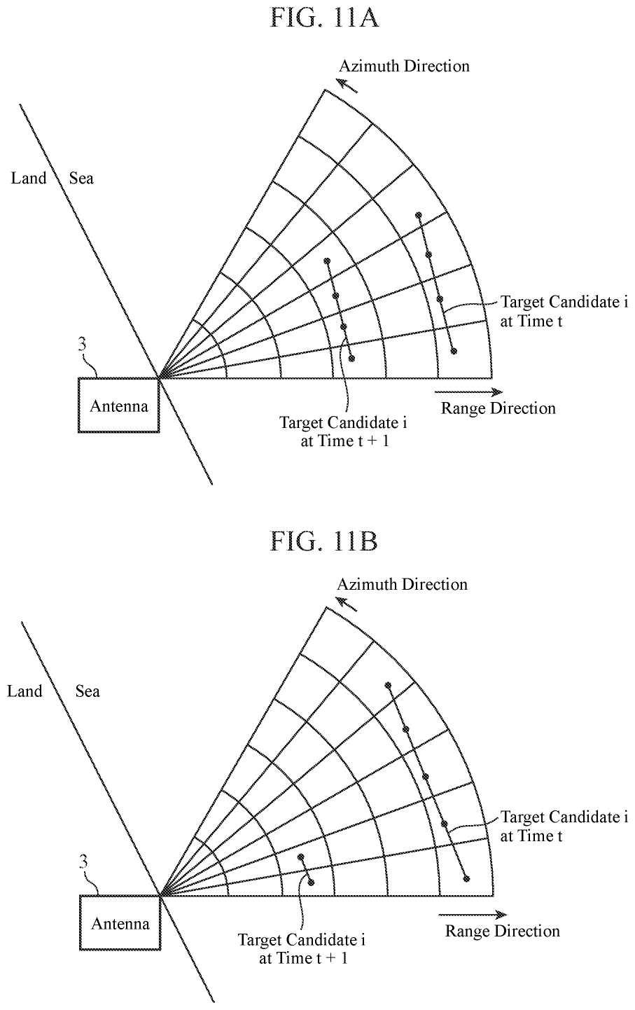

FIG. 11 is an explanatory drawing showing the target candidate i which is detected by the temporary detecting unit 14 at the sampling time t, and the target candidate i which is detected by the temporary detecting unit 14 at the sampling time t+1.

FIG. 11A shows an example in which the difference ΔLen between the length Lenₜ of the target candidate i at the sampling time t and the length Lenₜ₊₁ of the target candidate i at the sampling time t+1 is small. FIG. 11B shows an example in which the difference ΔLen between the length Lenₜ of the target candidate i at the sampling time t and the length Lenₜ₊₁ of the target candidate i at the sampling time t+1 is large.

It is assumed that the difference ΔLen in length between the target candidates i and i+1 is equal to or less than the threshold Lenₜₕ in FIG. 11A, and the difference ΔLen in length between the target candidates i and i+1 is greater than the threshold Lenₜₕ in FIG. 11B.

The target tracking unit 17 calculates the difference ΔLen between the length Lenₜ of the target candidate i and the length Lenₜ₊₁ of the target candidate i, and compares the difference ΔLen and the threshold Lenₜₕ. The threshold Lenₜₕ may be stored in an internal memory of the target tracking unit 17, or may be provided from the outside.

When the difference ΔLen is equal to or less than the threshold Lenₜₕ, as shown in FIG. 11A, the target tracking unit 17 recognizes that the target candidate i is an object of observation.

When the difference ΔLen is greater than the threshold Lenₜₕ, as shown in FIG. 11B, the target tracking unit 17 recognizes that the target candidate i is not an object of observation.

Because the length of a wave front of a tsunami hardly changes during one sampling time interval, the erroneous detection of a tsunami which is an object of observation can be prevented through the target tracking unit 17's recognition that a target candidate i whose length greatly changes is not an object of observation.

### Embodiment 3

In the radar device of Embodiment 1, the target recognizing unit 15 specifies a target candidate which has been determined continuously with respect to time to have a possibility of being an object of observation, out of the target candidates each of which is determined to have a possibility of being an object of observation by the temporary determining unit 11, and recognizes the specified target candidate as an object of observation.

In Embodiment 3, a radar device that includes a condition about the inclination of target candidates as a condition for recognizing, as an object of observation, a target candidate which is determined to have a possibility of being an object of observation by a temporary determining unit 11 will be explained.

The configuration of the radar device of Embodiment 3 is shown in FIG. 1, like that of the radar device of Embodiment 1.

First, a target tracking unit 17 performs the same determination as that of Embodiment 1.

More specifically, the target tracking unit 17 determines whether a determination result of a temporary detecting unit 14 at a sampling time t+1 shows that a target candidate i has a possibility of being an object of observation, and each cell Cⱼ in which the target candidate i is present is within a gate at the sampling time t+1.

Next, when the determination result of the temporary detecting unit 14 shows that there is a possibility of being an object of observation, and each cell Cⱼ is within the gate, the target tracking unit 17 determines whether the target candidate i satisfies the condition about the inclination.

The condition about the inclination is that the difference Δβ between the inclination βₜ of the target candidate i at the current sampling time t and the inclination βₜ₊₁ of the target candidate i at the next sampling time t+1 is equal to or less than a threshold βₜₕ.

The inclination βₜ of the target candidate i is the inclination of the target candidate i which is determined at the sampling time t to have a possibility of being an object of observation.

The inclination βₜ₊₁ of the target candidate i is the inclination of the target candidate i which is determined at the sampling time t+1 to have a possibility of being an object of observation.

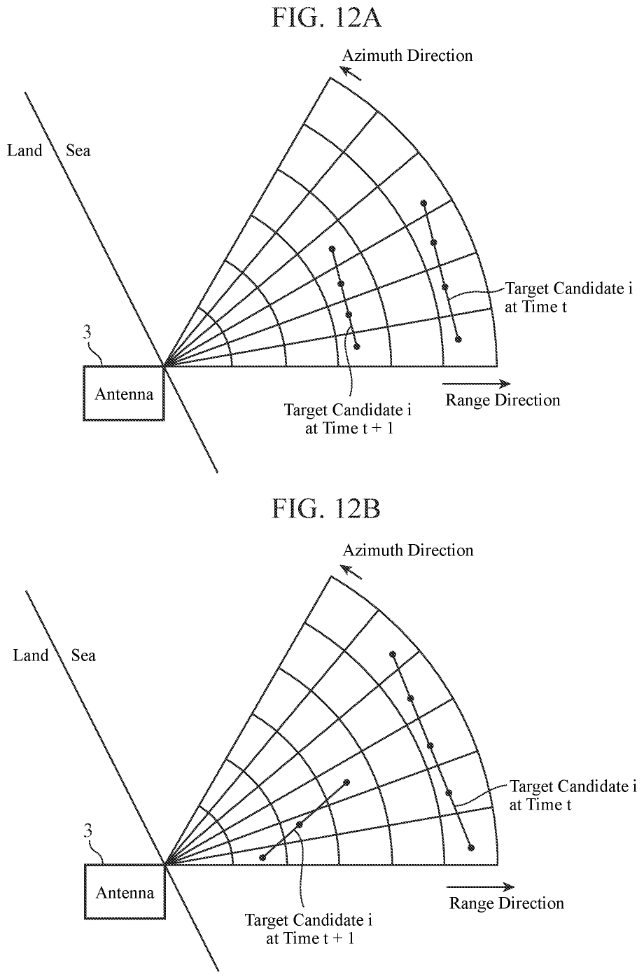

FIG. 12 is an explanatory drawing showing the target candidate i which is detected by the temporary detecting unit 14 at the sampling time t, and the target candidate i which is detected by the temporary detecting unit 14 at the sampling time t+1.

FIG. 12A shows an example in which the difference Δβ between the inclination βₜ of the target candidate i at the sampling time t and the inclination βₜ₊₁ of the target candidate i at the sampling time t+1 is small. FIG. 12B shows an example in which the difference Δβ between the inclination βₜ of the target candidate i at the sampling time t and the inclination βₜ₊₁ of the target candidate i at the sampling time t+1 is large.

It is assumed that the difference Δβ in inclination between the target candidates i and i+1 is equal to or less than the threshold βₜₕ in FIG. 12A, and the difference Δβ in inclination between the target candidates i and i+1 is greater than the threshold βₜₕ in FIG. 12B.

The target tracking unit 17 calculates the difference Δβ between the inclination βₜ of the target candidate i at the sampling time t and the inclination βₜ₊ᵢ of the target candidate i at the sampling time t+1, and compares the difference Δβ and the threshold βₜₕ. The threshold βₜₕ may be stored in an internal memory of the target tracking unit 17, or may be provided from the outside.

When the difference Δβ is equal to or less than the threshold βₜₕ, as shown in FIG. 12A, the target tracking unit 17 recognizes that the target candidate i is an object of observation.

When the difference Δβ is greater than the threshold βₜₕ, as shown in FIG. 12B, the target tracking unit 17 recognizes that the target candidate i is not an object of observation.

Because the inclination of a wave front of a tsunami hardly changes during one sampling time interval, the erroneous detection of a tsunami which is an object of observation can be prevented through the target tracking unit 17's recognition that a target candidate i whose inclination greatly changes is not an object of observation.

It is to be understood that any combination of two or more of the above-mentioned embodiments can be made, various changes can be made in any component according to any one of the above-mentioned embodiments, or any component according to any one of the above-mentioned embodiments can be omitted within the scope of the present disclosure.

### INDUSTRIAL APPLICABILITY

The present disclosure is suitable for a radar device and a signal processor that recognize, as an object of observation, a target candidate which has been determined continuously with respect to time to have a possibility of being an object of observation.

### REFERENCE SIGNS LIST

1 transmitting and receiving unit, 2 transmitter, 3 antenna, 4 receiver, 5 signal processor, 6 flow velocity calculating unit, 7 flow velocity calculation processing unit, 8 flow velocity storage unit, 9 tide subtracting unit, 10 candidate setting unit, 11 temporary determining unit, 12 depth of water storage unit, 13 flow rate calculating unit, 14 temporary detecting unit, 15 target recognizing unit, 16 determination result storage unit, 17 target tracking unit, 18 display device, 21 flow velocity calculating circuit, 22 candidate setting circuit, 23 temporary determining circuit, 24 target recognizing circuit, 31 processor, and 32 memory.

1. A radar device comprising:
processing circuitry to
radiate an electromagnetic wave toward an observation region and receiving the electromagnetic wave returning from the observation region;
calculate each of flow velocities of multiple cells included in the observation region from the received electromagnetic wave;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using the flow velocity of the cell in which the target candidate is present, out of the calculated flow velocities, and determining whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry predicts a combination of cells in each of which there is a possibility that a target candidate which is determined to have a possibility of being an object of observation is present at a next sampling time, and, when a target candidate which is determined to have a possibility of being an object of observation is present in the predicted cell combination at the next sampling time, the processing circuitry recognizes that the target candidate is an object of observation, and
wherein the processing circuitry predicts, as a combination of cells in each of which there is a possibility of being present at the next sampling time, a combination of cells each being present, at a current sampling time, in a traveling direction of a target candidate which is determined to have a possibility of being an object of observation.

2. A radar device comprising:
processing circuitry to
radiate an electromagnetic wave toward an observation region and receiving the electromagnetic wave returning from the observation region;
calculate each of flow velocities of multiple cells included in the observation region from the received electromagnetic wave;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using the flow velocity of the cell in which the target candidate is present, out of the calculated flow velocities, and determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry includes a condition that a difference between a length of the target candidate and a length of the target candidate which is determined at a next sampling time to have a possibility of being an object of observation is equal to or less than a threshold, as a condition under which a target candidate which is determined to have a possibility of being an object of observation is recognized as an object of observation.

3. A radar device comprising:
processing circuitry to
radiate an electromagnetic wave toward an observation region and receiving the electromagnetic wave returning from the observation region;
calculate each of flow velocities of multiple cells included in the observation region from the received electromagnetic wave;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using the flow velocity of the cell in which the target candidate is present, out of the calculated flow velocities, and determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry includes a condition that a difference between an inclination of the target candidate and an inclination of the target candidate which is determined at a next sampling time to have a possibility of being an object of observation is equal to or less than a threshold, as a condition under which a target candidate which is determined to have a possibility of being an object of observation is recognized as an object of observation.

4. A radar device comprising:
processing circuitry to
radiate an electromagnetic wave toward an observation region and receiving the electromagnetic wave returning from the observation region;
calculate each of flow velocities of multiple cells included in the observation region from the received electromagnetic wave;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using the flow velocity of the cell in which the target candidate is present, out of the calculated flow velocities, and determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry recognizes, as an object of observation, a target candidate which has been determined continuously with respect to time a predetermined number of times or more to have a possibility of being an object of observation, out of the target candidates each of which is determined to have a possibility of being an object of observation.

5. A radar device comprising:
processing circuitry to
radiate an electromagnetic wave toward an observation region and receiving the electromagnetic wave returning from the observation region;
calculate each of flow velocities of multiple cells included in the observation region from the received electromagnetic wave;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using the flow velocity of the cell in which the target candidate is present, out of the calculated flow velocities, and determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry determines whether each target candidate has a possibility of being an object of observation, on a basis of both a flow rate of a cell in which the target candidate is present, and a flow rate distribution of a cell in which the target candidate is present when each target candidate is not an object of observation.

6. A radar device comprising:
processing circuitry to
radiate an electromagnetic wave toward an observation region and receiving the electromagnetic wave returning from the observation region;
calculate each of flow velocities of multiple cells included in the observation region from the received electromagnetic wave;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using the flow velocity of the cell in which the target candidate is present, out of the calculated flow velocities, and determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein when there are two or more target candidates each of which is determined to have a possibility of being an object of observation, the processing circuitry determines the two or more target candidates as different target candidates when a difference or differences in inclination between the two or more target candidates are equal to or greater than a threshold, whereas the processing circuitry determines the two or more target candidates as one identical target candidate when the difference or differences in inclination between the two or more target candidates are less than the threshold.

7. The radar device according to claim 1,
wherein the processing circuitry subtracts a tide component from each of the flow velocities of the multiple cells and outputs each of the flow velocities after the subtraction of the tide component.

8. The radar device according to claim 1,
wherein when there are two or more target candidates each of which is determined to have a possibility of being an object of observation, the processing circuitry determines the two or more target candidates as different target candidates when a distance or distances between the two or more target candidates are equal to or greater than a threshold, whereas the processing circuitry determines the two or more target candidates as one identical target candidate when the distance or distances between the two or more target candidates are less than the threshold.

9. A signal processor comprising:
processing circuitry to
calculate each of flow velocities of multiple cells included in an observation region from the electromagnetic wave returning from the observation region;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using a flow velocity of the cell in which the target candidate is present, out of the calculated flow velocities, and determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry predicts a combination of cells in each of which there is a possibility that a target candidate which is determined to have a possibility of being an object of observation is present at a next sampling time, and, when a target candidate which is determined to have a possibility of being an object of observation is present in the predicted cell combination at the next sampling time, the processing circuitry recognizes that the target candidate is an object of observation, and
wherein the processing circuitry predicts, as a combination of cells in each of which there is a possibility of being present at the next sampling time, a combination of cells each being present, at a current sampling time, in a traveling direction of a target candidate which is determined to have a possibility of being an object of observation.

10. A signal processor comprising:
processing circuitry to
calculate each of flow velocities of multiple cells included in an observation region from the electromagnetic wave returning from the observation region;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using a flow velocity of the cell in which the target candidate is present, out of the calculated flow velocities, and for determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry includes a condition that a difference between a length of the target candidate and a length of the target candidate which is determined at a next sampling time to have a possibility of being an object of observation is equal to or less than a threshold, as a condition under which a target candidate which is determined to have a possibility of being an object of observation is recognized as an object of observation.

11. A signal processor comprising:
processing circuitry to
calculate each of flow velocities of multiple cells included in an observation region from the electromagnetic wave returning from the observation region;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using a flow velocity of the cell in which the target candidate is present, out of the calculated flow velocities, and for determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry includes a condition that a difference between an inclination of the target candidate and an inclination of the target candidate which is determined at a next sampling time to have a possibility of being an object of observation is equal to or less than a threshold, as a condition under which a target candidate which is determined to have a possibility of being an object of observation is recognized as an object of observation.

12. A signal processor comprising:
processing circuitry to
calculate each of flow velocities of multiple cells included in an observation region from the electromagnetic wave returning from the observation region;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using a flow velocity of the cell in which the target candidate is present, out of the calculated flow velocities, and for determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry recognizes, as an object of observation, a target candidate which has been determined continuously with respect to time a predetermined number of times or more to have a possibility of being an object of observation, out of the target candidates each of which is determined to have a possibility of being an object of observation.

13. A signal processor comprising:
processing circuitry to
calculate each of flow velocities of multiple cells included in an observation region from the electromagnetic wave returning from the observation region;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using a flow velocity of the cell in which the target candidate is present, out of the calculated flow velocities, and for determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein the processing circuitry determines whether each target candidate has a possibility of being an object of observation, on a basis of both a flow rate of a cell in which the target candidate is present, and a flow rate distribution of a cell in which the target candidate is present when each target candidate is not an object of observation.

14. A signal processor comprising:
processing circuitry to
calculate each of flow velocities of multiple cells included in an observation region from the electromagnetic wave returning from the observation region;
select multiple combinations of one or more cells consecutively arranged, out of the multiple cells included in the observation region, assume that an object of observation is present in each of the selected cell combinations, and set up each of objects of observation as a target candidate;
calculate a flow rate of a cell in which each target candidate is present, by using a flow velocity of the cell in which the target candidate is present, out of the calculated flow velocities, and for determine whether each target candidate has a possibility of being an object of observation, on a basis of the flow rate; and
specify a target candidate which has been determined continuously with respect to time to have a possibility of being an object of observation, out of target candidates each of which is determined to have a possibility of being an object of observation, and recognize the specified target candidate as an object of observation,
wherein when there are two or more target candidates each of which is determined to have a possibility of being an object of observation, the processing circuitry determines the two or more target candidates as different target candidates when a difference or differences in inclination between the two or more target candidates are equal to or greater than a threshold, whereas the processing circuitry determines the two or more target candidates as one identical target candidate when the difference or differences in inclination between the two or more target candidates are less than the threshold.
